(19) United States
(12) Patent Application Publication
(10) Pub. No.: US 2024/0183142 A1
(43) Pub. Date: Jun. 6, 2024

(54) SYSTEM AND METHOD FOR ADVANCED PORTABLE BATHROOM FACILITIES

(71) Applicant: Throne Labs, Inc., Charlottesville, VA (US)

(72) Inventors: Ben Clark, Charlottesville, VA (US); Fletcher Wilson, Charlottesville, VA (US); Oleksandr Novikov, Charlottesville, VA (US); Jessica Heinzelman, Charlottesville, VA (US); Shyanne Telfer, Charlottesville, VA (US); Al Barrientos, Charlottesville, VA (US); Juan Paz, Charlottesville, VA (US); Kyle Visner, Charlottesville, VA (US); William Gibbs, Charlottesville, VA (US); Max Cerami, Charlottesville, VA (US)

(21) Appl. No.: 18/073,283

(22) Filed: Dec. 1, 2022

(51) Int. Cl. E03D 9/04; E03B 7/07; F24F 11/46; G05B 19/042; G06Q 10/20; H02S 10/20

(52) U.S. Cl. CPC E03D 9/04; E03B 7/07; F24F 11/46; G05B 19/042; G06Q 10/20; H02S 10/20; F24F 2120/10

(57) ABSTRACT

In various embodiments, portable bathroom facilities disclosed herein can employ various features that can use data from one or more sensors, devices, etc. to provide enhanced bathroom management and user experience.

### TECHNICAL FIELD

The present disclosure relates to portable bathroom facilities and, in particular, to advanced features for portable bathroom facilities.

### BACKGROUND

Public restrooms are provided through the world in various locations such as parks and other outdoor city areas, job sites and concerts, festivals, campgrounds and other outdoor gatherings, etc. In many circumstances, such public restrooms are provided as portable restrooms that are not connected to water or sewage and can be temporarily placed in a location or at an event and removed or may remain at a location in a semi-permanent fashion while being periodically cleaned and services. These portable restrooms can be filled with unpleasant odors and sights due to the storage of waste in the restroom, may be unsanitary due to irregular cleaning and can be costly to acquire and maintain. They can also be the subject of vandalism or other improper use that results in a disagreeable atmosphere in the bathroom. As a result, use of portable bathrooms can be unpleasant and some people avoid using such bathrooms altogether due to these reasons.

### SUMMARY

In various embodiments, portable bathroom facilities disclosed herein can employ various features that can use data from one or more sensors, devices, etc. to provide enhanced bathroom management and user experience.

In an embodiment, a smart bathroom facility can include a structure containing one or more bathroom elements and at least one processor and a battery configured to provide power to one or more of the bathroom elements. An occupancy sensing system within the structure and communicatively linked to the at least one processor such that the processor can determine from data from the occupancy sensing system whether a user is present within the structure. One of the bathroom elements can be an HVAC system and the at least one processor can be configured to control the HVAC system to selectively modify one or more of heating, air conditioning and ventilation services based on the data from the occupancy sensing system in order to conserve power in the battery.

In an embodiment, a smart bathroom facility system can include a plurality of amenities, each including a structure including at least one processor and containing one or more bathroom elements including a freshwater holding tank configured to contain freshwater. An operations management system can be communicatively coupled to the at least one processor of each of the plurality of amenities. A water volume sensor can be configured to measure a volume of water with the freshwater holding tank of at least some of the amenities. The operations management system can be configured to monitor the volume of water within the freshwater holding tank of the at least some of the amenities and to prioritize routing of one or more service vehicles to the at least some of the amenities based on the volume of water within the freshwater holding tank of the at least some of the amenities.

In an embodiment, a smart bathroom facility system can include a plurality of amenities, each amenity including a structure including at least one processor and containing one or more bathroom elements. An operations management system can be communicatively coupled to the at least one processor of each of the plurality of amenities and include a cleanliness tracking system configured to receive user reviews of the plurality of amenities to determine a cleanliness status for each of the amenities. The operations management system can be configured to cause the at least one processor of an amenity to switch the amenity into an offline mode in which the amenity is unavailable for normal use based on the cleanliness status of the amenity.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1A is a front perspective view of a bathroom according to an embodiment.

FIG. 1B is a front view of the bathroom of FIG. 1A.

FIG. 1C is a back view of the bathroom of FIG. 1A.

FIG. 1D is a left view of the bathroom of FIG. 1A.

FIG. 1E is a right view of the bathroom of FIG. 1A.

FIG. 1F is a top view of the bathroom of FIG. 1A.

FIG. 1G is a bottom view of the bathroom of FIG. 1A.

FIG. 1H is a back perspective view of the bathroom of FIG. 1A.

FIG. 1I is a partial back perspective view of the bathroom of FIG. 1A.

FIG. 1J is a partial top-down view of the bathroom of FIG. 1A.

FIG. 1K is a partial front perspective view of the bathroom of FIG. 1A.

FIG. 2 is a block diagram of a system for managing publicly accessible amenities, according to an embodiment.

FIG. 3 is a flowchart depicting operation of an HVAC system for a publicly accessible amenity according to an embodiment.

FIG. 4 is a flowchart depicting operation of an HVAC system for a publicly accessible amenity according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

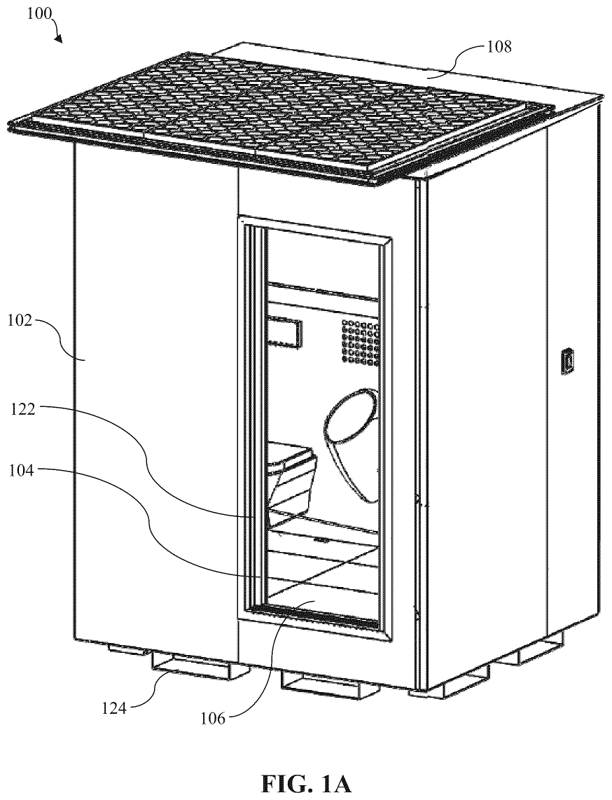

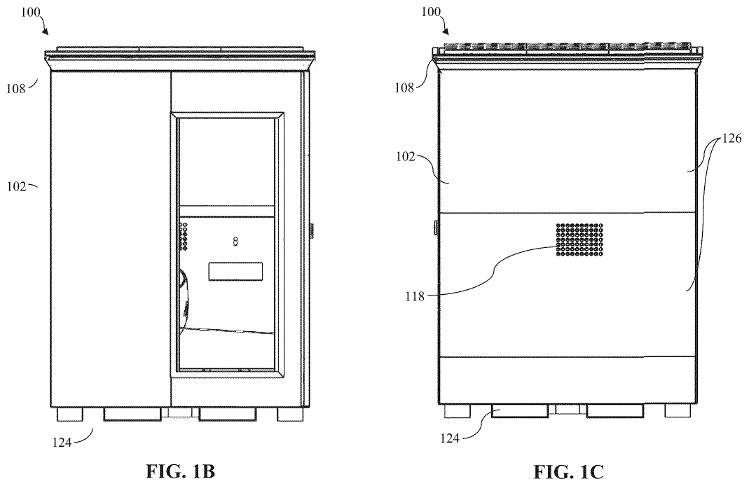

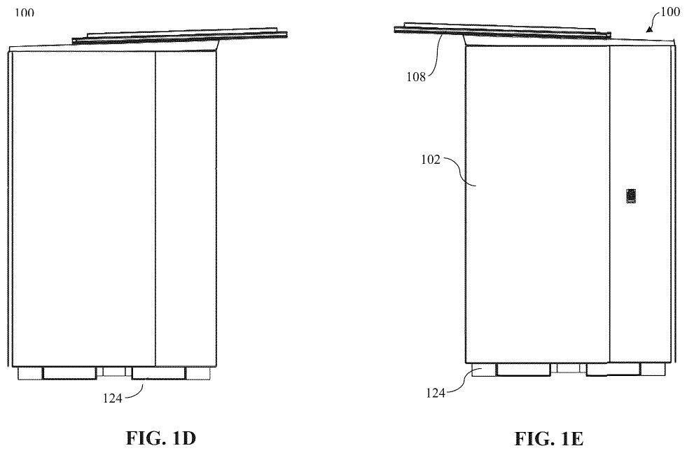

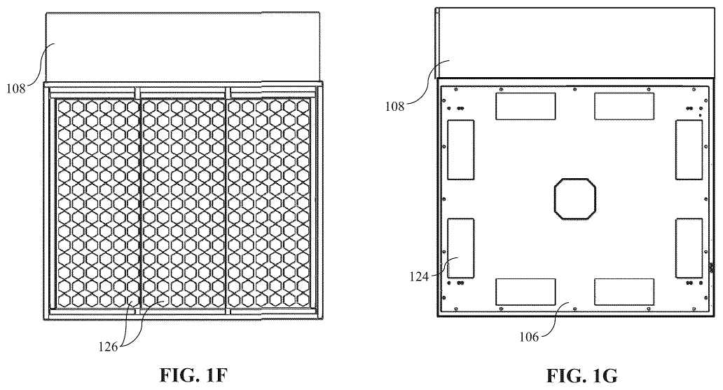

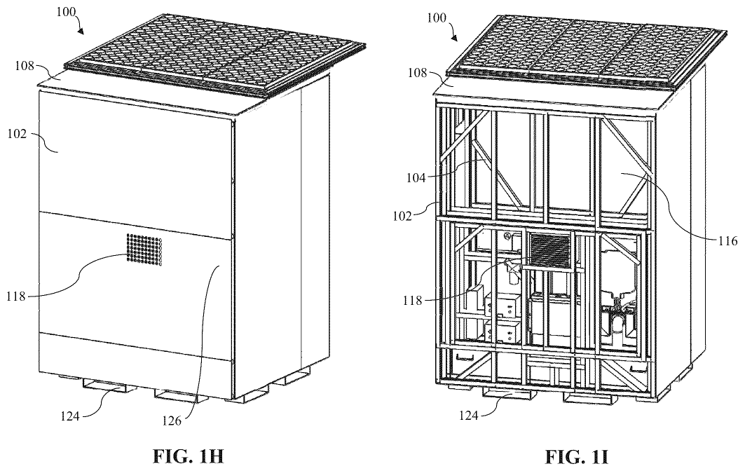

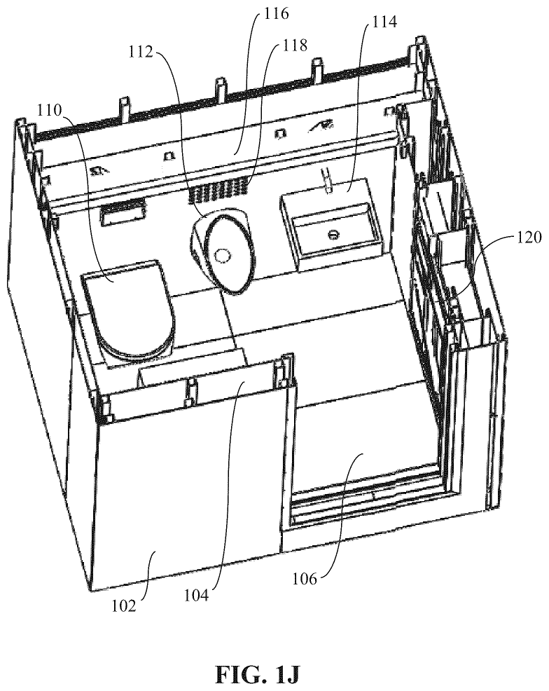

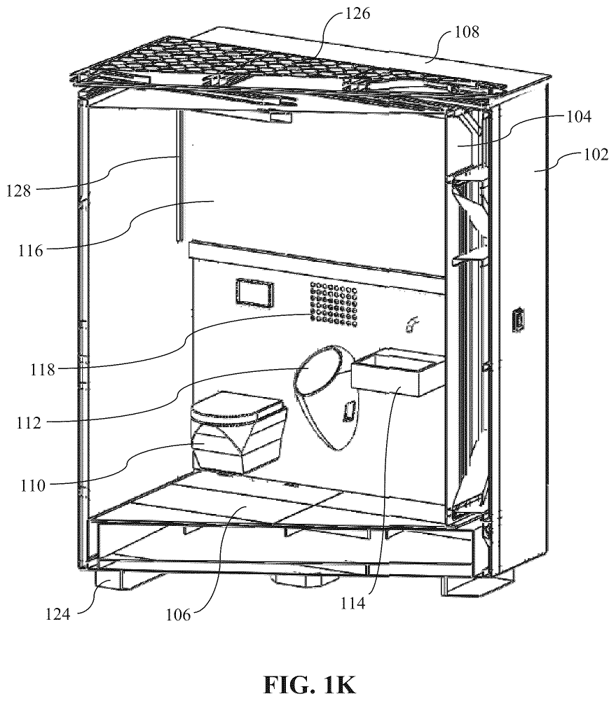

Referring to FIGS. 1A-1K, a portable bathroom 100 with smart features is depicted according to an embodiment. Bathroom 100 generally comprises exterior walls 102, interior walls 104, floor 106, and roof 108 defining an enclosed space that includes bathroom elements. Bathroom elements can include toilet 110, urinal 112, sink 114, mirror 116, HVAC system 118, cleaning supply compartment 120, and lights 128. Entry to the enclosed space is controlled by door 122.

In embodiments, door 122 is a pocket door that is configured to slide between exterior walls 102 and interior walls 104 when in an open position. Such embodiments allow for more convenient use of space in the interior of bathroom 100 and improved safety as users approaching an occupied bathroom 100 are not at risk of being hit by an opening door. Locking and opening of door 122 can be done electronically such that contactless entry and exit is possible.

The space between exterior walls 102 and interior walls 104, below floor 106, and above roof 108 can be configured to house a freshwater tank, a graywater tank, and a wastewater tank for use with a plumbing system. In embodiments, the freshwater tank can be located above the bathroom elements to facilitate a strong flow of water and the wastewater tank can be located below the bathroom elements to receive sewage and used water. In some embodiments, the freshwater tank can be positioned at or below the bathroom elements and an electric pump can be utilized to facilitate a strong flow of water. In some embodiments, the wastewater tank can be located at or above the bathroom elements, with use of a macerating pump to break down sewage and move it to the elevated wastewater tank.

One or more exterior walls 102 can comprise panels 126 that can be independently removed to provide access to components, such as the graywater tank or HVAC system 118, stored between exterior walls 102 and interior walls 104. In embodiments, removal of panels 126 can be secured with a locking mechanism that requires user identification or presentation of a key before access is permitted.

Floor 106 can be raised by supports 124 such that the enclosed space has clearance from the ground. Supports 124 can allow for more flexibility in where bathroom 100 may be deployed. In embodiments, supports 124 can be spaced across floor 106 or made hollow to allow for secure transport by a forklift or other means. In some embodiments, the system includes adjustable feet at or near the corners of the structure. These feet allow for a unit to be placed on uneven ground. The feet may include extra support for lateral forces. The feet may include jacks or similar mechanisms to transition rotational motion into translational motion so that a hand drill or similar can be used to raise or lower the feet. In some embodiments supports 124 could be removable, to provide tipping support to a fork, but that could be removed during placement to reduce the final resting height of the floor compared to the ground under the amenity.

Roof 108 can extend past exterior walls 102 from one or more sides to provide shade and cover from precipitation. In embodiments, roof 108 can optionally incorporate or otherwise support one or more solar panels 126 configured to power a battery of bathroom 100. Solar panels may also be affixed to roof extensions past the exterior wall. Solar panels may also be affixed to vertically oriented poles with articulation permitted by a hinging bracket affixed to the poles. The battery can be used to power electric elements of bathroom 100, including operation of door 122, lights 128, audio systems, smart locks, motors, actuators, valves, pumps, HVAC systems and one or more sensing modules configured to record data and detect status conditions of bathroom 100. One or more sensing modules can include weight sensors, light-based sensors, temperature sensors, cameras, microphones, and the like.

Power can be conserved by turning off the one or more lights 128, limiting the transmission of data packets from the unit to the cloud, limiting power supplied to the HVAC unit, limiting power supplied to one or more sensing modules, or limitation of any power consuming feature when the bathroom is not occupied. In embodiments, bathroom 100 can enter a low-power or sleep state after a predetermined period of time, such as five minutes without occupancy, or during certain times of day, or when state of charge sensors drop below a certain configurable threshold, or when a combination of current charge status, and predicted energy needs, and predicted energy input from solar (i.e. weather predictions) falls below a threshold that warrants power conservation.

In embodiments where roof 108 includes an overhang past the exterior wall 102 that includes a door 122, a sensing module can be placed on the overhang, or on the door frame exterior to the door, such that when door 122 is in an open position data regarding the state of the enclosed space can be collected. Placement of such a sensing module, such as a camera, can enable data to be collected from the interior of bathroom 100 while complying with privacy regulations.

In some embodiments, a microphone is placed in the utility wall near the toilet drain pipe to detect sounds of an improperly flushing toilet (such as a clog). Machine learning is employed over time learn the sounds of proper and improperly flushing toilets with more dexterity over time, by pairing sensing results with customer or service member validations of certain real world events.

In some embodiments, a microphone is be placed on the interior of the unit, and machine learning algorithms in the backend are similarly used to learn how to detect the sounds or motions of vandalism or other abuse of the portable bathroom, such as breaking, pounding, attempted tipping, tampering with sensors, drug consumption, sexual activity, or other inappropriate activities, as well as signals of duress which could require assistance from authorities.

Accordingly, embodiments of the present disclosure provide for a solar-powered and self-contained portable bathroom 100 that does not require any on-site construction. Bathroom 100 includes the capability to have running water and robust ventilation that can be accessed with touchless entry and exit to provide a pleasant user experience. No connections to external power, water or sewage are required.

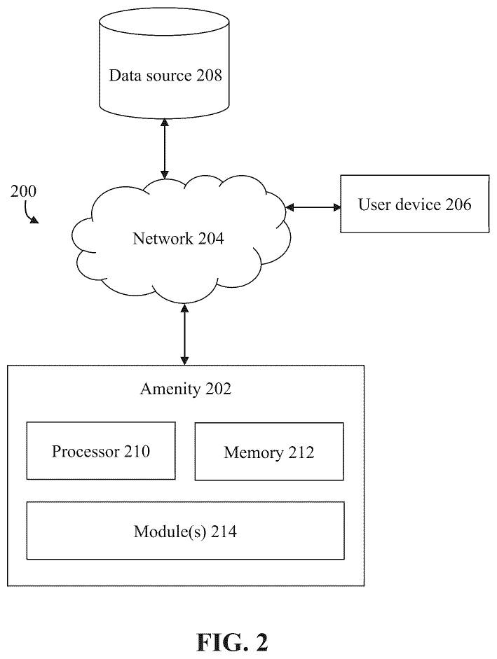

Referring to FIG. 2, a block diagram of a system 200 for managing publicly accessible amenities is depicted, according to an embodiment. System 200 can be used to permit user access to and operation of amenities and generally comprises amenity 202, network 204, user device 206, and data source 208.

In embodiments, amenity 202 can be a smart bathroom such as bathroom 100. Amenity 202 generally comprises a processor 210, memory 212, and at least one module 214. Examples of amenity 202 include restrooms, vending machines, vehicles, storage lockers, changing rooms, photo booths, showers, temporary offices, phone booths, laundry pods, medical diagnostic booths, voting booths, breast pumping spaces and the like. The term “amenity” will be used herein throughout for convenience but is not limiting with respect to the actual features, characteristics, or composition of any smart enclosure or system that could embody amenity 202.

Processor 210 can be any programmable device that accepts digital data as input, is configured to process the input according to instructions or algorithms and provides results as outputs. In an embodiment, processor 210 can be a central processing unit (CPU) or a microcontroller or microprocessor configured to carry out the instructions of a computer program. Processor 210 is therefore configured to perform at least basic arithmetical, logical, and input/output operations.

Memory 212 can comprise volatile or non-volatile memory as required by the coupled processor 210 to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, or optical disc storage, for example. The foregoing lists in no way limit the type of memory that can be used, as these embodiments are given only by way of example and are not intended to limit the scope of the present disclosure.

Module 214 refers to any hardware or software that is constructed, programmed, configured, or otherwise adapted to autonomously carry out a function or set of functions, such as detecting a user device 206 or communicating with data source 208. The term “module” as used herein is defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which (while being executed) transform the microprocessor system into a special-purpose device. Module 214 can also be implemented as a combination of the two, with certain functions facilitated by hardware alone, and other functions facilitated by a combination of hardware and software. In certain implementations, at least a portion, and in some cases, all, of module 214 can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module 214 can be realized in a variety of physically realizable configurations and should generally not be limited to any particular implementation exemplified herein, unless such limitations are expressly called out.

In embodiments, module 214 can itself be composed of more than one sub-module, each of which can be regarded as a module in its own right. Moreover, in the embodiments described herein, each module 214 corresponds to a defined autonomous functionality; however, it should be understood that in other contemplated embodiments, each functionality can be distributed to more than one module. Likewise, in other contemplated embodiments, multiple defined functionalities may be implemented by a single module that performs those multiple functions, possibly alongside other functions, or distributed differently among a set of engines than specifically illustrated in the examples herein.

System 200 can be implemented irrespective of the number or type of module 214, although it can be beneficial in some embodiments to have module 214 arranged at a known position relative to the structure of amenity 202. In embodiments, module 214 can be within or outside the structure of amenity 202 or stored in a housing independent of amenity 202. For example, module 214 may be a scanner located external to bathroom 100 and configured to provide access to bathroom 100 upon detecting a QR code on user device 206. The position of module 214 external to amenity 202 can allow a module 214 configured to control user access to be used across several amenities.

Amenity 202 is configured to provide two-way data communication with network 204 via a wired or wireless connection. The specific design and implementation of an input/output module of amenity 202 can depend on the communications network(s) over which amenity 202 is intended to operate. Amenity 202 can, via network 204, access stored data from at least one data source 208.

In embodiments, network 204 can be in communication with a server, such as a cloud-based server, and serverless solutions, such as Lambdas or any other cloud based or self-hosted services, all of which can include a memory and at least one data processor. In addition, the server can collect and retrieve data from one or more external sources, such as a variety of navigational services or user management services. The one or more external sources can assist the server with providing amenity 202 with information characterizing a user profile associated with user device 206 in real-time. In embodiments, the one or more external sources can collect a variety of data from amenity 202 that can include one or more of occupation status, cleanliness rating, amenity location, and the like.

User device 206 generally comprises processing and memory capabilities and can establish a wireless connection with network 204 or otherwise communicate to amenity 202, such as by Bluetooth, or communicate with network 204 using external services as a proxy. Examples of user device 206 include smartphones, tablets, laptop computers, wearable devices, such as smart watches or smart glasses other consumer electronic devices or user equipment (UE), and the like. The term “user device” will be used herein throughout for convenience but is not limiting with respect to the actual features, characteristics, or composition of the or any device that could embody user device 206. In embodiments, user device 206 can run an instance of an application or user interface designed to facilitate user interaction with one or more features of amenity 202. In embodiments, user device 206 can be associated with one or more user profiles.

Data source 208 can be one or more general-purpose database management storage systems (DBMS). Data source 208 can be one or more relational or nonrelational DBMS as implemented by, for example, Oracle, IBM DB2, Microsoft SQL Server, PostgreSQL, MySQL, SQLite, Linux, or Unix solutions. Data source 208 can store one or more data sets associated with user devices 206 or associated with a user or amenities 202. In embodiments, data source 208 can be native to amenity 202 such that no connection to network 204 is necessary. In embodiments, data source 208 can receive data directly from amenities 202 through different cloud services.

One purpose of data source 208 is to store a plurality of navigational data that can map locations of one or more amenities 202 such that user device 206 can be provided directions to nearby amenities 202. Maps communicated to user device 206 can be an effective way to compare amenities and can include representations such as availability, business, cleanliness, parking availability, included internal amenities, accessibility information, temperature, recent service status, current length of queue, and any other features specific to amenities. In an embodiment, amenities can be identified by pins on a map with a cleanliness score represented by the color of each pin and estimated wait time displayed on each pin. In another embodiment, amenities can be identified by pins on a map, with availability represented by the color of each pin. In another embodiment, amenities can be identified by pins on a map, and further information about a particular amenity is displayed on a detail card, visible only when a pin is selected via touch screen interface or other means.

In embodiments users can add data such as new digital representations of external amenities, such as existing publicly available bathrooms, retail bathrooms, or other relevant amenities, to the data source 208 using user devices 206 with running an instance of the application over the network 204. This user-generated content may be part of the system and have a similar visual representation in the app or user interface as the previously represented amenities or include an indication that that amenity was added by a user and not the company. User-generated content can also include adding any data related to newly added or existing amenities that will be publicly available, or available to certain users with specific access levels. This user generated data can include reviews, ratings, cleanliness scores, amenities location data, existence or absence of certain specific utilities (e.g., baby changing table, grab bars, toilet paper levels), or any other data relevant to an amenity. Input data may also include incident or safety reporting. Access to view the user generated amenities may be restricted to certain users with certain access permissions.

System 200 represents an improvement over conventional amenity management approaches that fail to leverage user identification and accountability and is therefore able to provide a more pleasant user experience. Navigational data can be used to help direct users to available amenities 202 and reduce wait times. Additionally, system 200 can alleviate cleanliness concerns of users by monitoring cleanliness levels of amenities and providing alerts to staff when operation or cleanliness conditions are not met. System 200 can utilize negative cleanliness data or communications stemming from sensors or direct user communication to be automatically removed from the map or digital representations of the amenity and put into an out of service mode, via external signage, to properly communicate to potential users of the unit's status, and the unit would be inaccessible to future users until service was provided to the amenity. System 200 further provides automated management of amenities 202 that can reduce overhead cost of maintaining amenities through data informed operational infrastructure.

### Smart HVAC System

In embodiments, a portable bathroom unit can employ a smart heating ventilation and air conditioning (HVAC) system that can be employed to enhance the user experience in the bathroom facility compared to a typical portable restroom and to maintain the restroom in superior condition to a typical portable restroom. The system can also be employed to enable elevated user experience without requiring access to the electric grid (i.e., on solar power and battery storage alone). The system can utilize real-time data acquired by a variety of different sensors in a number of different ways to achieve these goals and can be operated with the solar power acquired by the solar panels of the unit to provide features that would not be possible in a typical portable bathroom. The system can include on board firmware and one or more microprocessors that determine the need for any such actions based on the sensed data and the amount of power available for such actions.

One aspect of such a system can be a power efficient air conditioning and heating system. In embodiments, this system can use real-time data about the occupancy/presence of a user and temperature readings from one or more temperature sensers inside and/or outside of the unit to provide high energy amenities for a limited amount of time to enhance the user's experience. For example, if the temperature inside and/or outside is above a high temperature threshold, the system can activate high flow air conditioning. If the temperature inside and/or outside is below a low temperature threshold, the system can activate resistive or ambient heating. In various embodiments, these amenities can be activated upon detection of a user entering the unit for the entirely of time the user is using the unit, for a portion of the use (e.g., upon entry for a predetermined period of time regardless of when the use ends), following use for a specified amount of time, and/or for a time during use determined by the stage of use the user is in (e.g., until the user finishes using the toilet, but before washing hands).

Another aspect of a smart HVAC system as disclosed herein can be a smart ventilation system that can vary the initialization and duration of ventilation, air conditioning, or heating powered by the unit's solar power and/or stored battery power based on various factors and real-time data used to determine when ventilation, air conditioning or heating are needed. For example, if a user has been using the unit for an amount of time over a threshold amount of time the system can be activated. The system can also be activated or increased when it is detected that the toilet has been flushed and/or increased based on a number of times the toilet has been flushed. Ventilation, heating or air conditioning can also be activated or increased based on a temperature in the unit or the presence and/or density of methane or other volatile organic compounds in the unit as detected by a corresponding sensor. Ventilation, heating or air conditioning can also be varied based on a location of a user in the unit as detected by, for example, a weight sensor array within the unit. For example, ventilation may be activated and/or increased when the user is detected as being on or close to a toilet or close to a urinal as opposed to when the user is closer to or at the sink.

A further aspect of a smart HVAC system as disclosed herein according to some embodiments is the use of power-efficient anti-freezing techniques that can be employed to prevent critical plumbing fixtures from freezing in sub-freezing environments. For example, temperature sensors can be located in a plurality of locations around the unit in or near certain high-risk areas for freezing of piping and/or liquid reservoirs. In embodiments, additional insulation and/or localized heating elements, such, as for example, heat strips, heat pads, heat wires and/or heat wraps can be located at these high-risk areas. These localized heating elements can be selectively activated based on readings from the temperature sensors to prevent freezing. For example, if the temperature sensed by a temperature sensor drops below a low temperature threshold, the corresponding heating element can be activated for a predetermined period of time and/or until the temperature reaches a predetermined safe threshold. The system can alternatively or additionally include pumps that can be activated based on temperature readings to move water around within the system using kinetic energy to decrease the possibility of the water freezing.

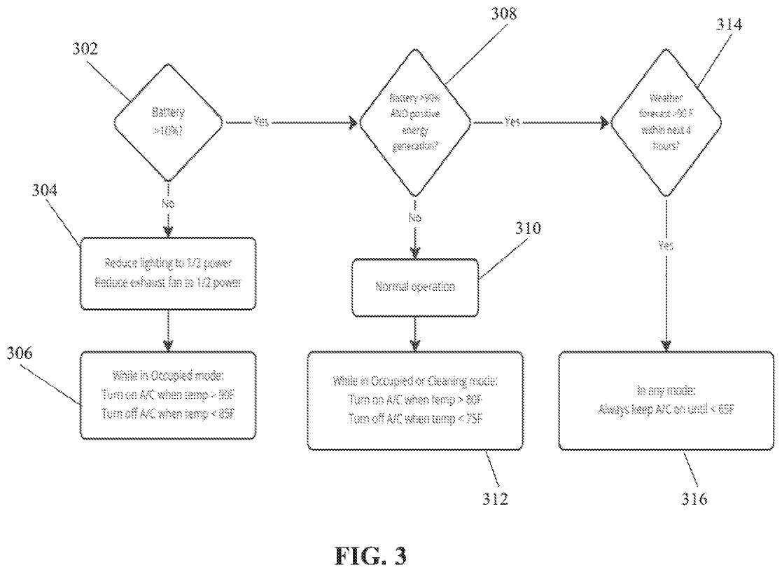

FIG. 3 depicts a flowchart of one exemplary embodiment of a smart HVAC system according to the disclosure. At step 302 the system determines whether the stored energy in the battery is greater or less than a low threshold of, e.g., 10% of battery capacity. If not, certain amenities can be reduced at step 304, such as, for example by reducing lighting and/or the exhaust fan to, e.g., one half of maximum power. In addition, at step 306 air conditioning can be reduced such that, for example, the air conditioning is only turned on when the internal temperature is above a high threshold such as 90 degrees Fahrenheit and is turned back off anytime the temperature falls back below a relatively high threshold such as 85 degrees Fahrenheit. If the battery level is above the low threshold, the system can next determine at step 308 whether the battery level is above a high threshold level such as, e.g., 90% capacity alone or in conjunction with positive energy being generated (i.e., with the solar panel) at that time. If not, the system can be operated in a typical or normal fashion at step 310 which can include turning the air conditioning on and off at lower internal temperature thresholds than those when the battery is low on energy at step 312. If the battery level is above the high threshold and/or positive energy is being generated the system can determine at step 314 if the weather forecast indicates that the outside temperature will be over a high temperature threshold (e.g., 90 degrees) within a certain period of time (e.g., 4 hours). If so, at step 316 the unit can be operated in a high energy mode that keeps the air conditioning on to maintain the temperature at a threshold lower than the normal operating temperatures (e.g., 65 degrees). In embodiments, weather forecasting including cloudiness or lack of clouds, may be used to determine estimated solar power generation over the next few hours, and such information may also be a decision point to determine if the unit is allowed to remain in normal operational mode or if it should be placed in a low energy consumption mode, if the weather forecast is more cloudy.

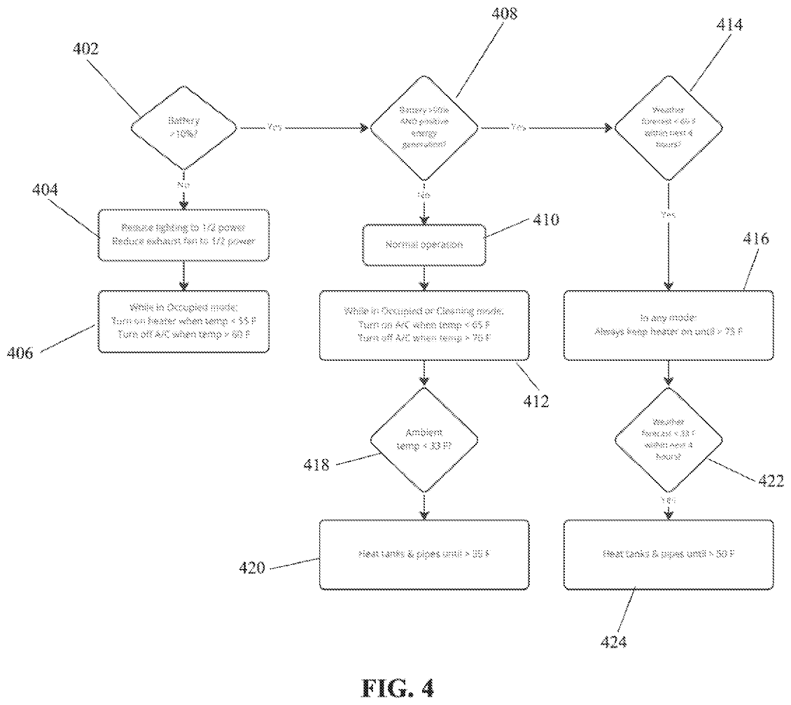

FIG. 4 depicts a flowchart of a similar system for controlling heating in a unit as opposed to air conditioning as described with respect to FIG. 3. Steps 402-416 are substantially similar and relate to varied thresholds for control of heating based on battery level in a similar fashion to the control of air conditioning in FIG. 3. As noted above, in addition to heating of the interior of unit the HVAC system can also be employed to selectively heat the water tanks, pipes, and/or other areas in which liquid is contained or may flow. As such, when in normal operation at step 410, the system can further determine whether the temperature is below a low threshold such as 33 degrees Fahrenheit at step 418 and, if so, activate heating of water tanks and/or pipes until heating to a sufficient level (e.g., 35 degrees) at step 420. Such a feature may be deactivated when the system is in the low power mode. When in high energy mode, the system may further evaluate the weather forecast to determine whether the temperature will be below a certain threshold (e.g., 33 degrees) within a predetermined amount of time (e.g., 4 hours) at step 422 and, if so, proactively heat the tanks and/or pipes to a higher level (e.g., 50 degrees) than in normal mode.

Although specific percentages, temperatures, etc. have been used in the above examples, it should be understood that these are illustrative only and various other figures could be used.

### Smart Energy Utilization

In embodiments, portable bathroom units as disclosed herein can employ a smart energy utilization system to optimize power usage in the system. Such a system can employ two primary sub-systems, a system to track current energy and a system to predict energy inputs and needs in the near future. The current energy tracking system can track both an existing battery voltage (i.e., existing power in the batteries) and a current energy input being acquired via the unit's solar panels. The predicted energy system can integrate multiple data sources to predict future energy needs and incoming solar energy. Predictions of upcoming or future energy utilization can be based on historical data usage for the unit and/or nearby or otherwise similarly situated units for one or more of similar times of day, day of week, month or other historical event-based usage. Historical comparison may be made based on categorical similarities such as location type, hosting customer type, distribution of user profile types, climate, region or other. Future incoming energy predictions can be based on weather predictions (i.e., amount of sunlight) through a connection to internet-based weather services.

In operation, the smart energy utilization system can be configured to toggle between two or more energy utilization modes based on these inputs. Lower power modes can be employed at any time, for intermittent periods or extended periods, when current energy and/or future energy is low and/or utilization is expected to be high, such that the unit can maintain more limited functionality that still functions as a useable bathroom such as use of the toilet and sink without providing higher energy luxury amenities such as the smart HVAC system described above, lighting, etc. Higher energy modes employed when current energy is high and/or future energy is predicted to be high and/or utilization is expected to be low can provide a full range or near a full range of available amenities for intermittent or extended periods of time. A medium mode, or a range of medium modes, can be employed when neither the lower or higher power modes are appropriate. In such medium modes, higher energy amenities may be available, but may be restricted in time or in scope. For example, when in a medium energy mode a higher energy amenity such as ventilation may be provided but for a shorter period of time and/or at a reduced speed/power than during a high energy mode. A continuum of energy modes may be available, involving smooth or near smooth automatic adjustability of certain energy consuming components, systems or processes. Such adjustments may occur over an intermittent or short timeline, such as once per hour, once per minute, once per use, once per second, or once every fraction of a second, so that the system may be optimized for a certain desirable metric such as total longevity of functionality, total number of uses, total number of uses during an advantageous time interval (such as a service contract with a time component).

### Smart User Experience Features

Portable bathroom units as described herein can further employ any of a number of smart features designed to enhance the user experience. For example, as noted above a user may gain entry to a portable bathroom unit via a software application or other interaction using the user's smartphone or other user device. The smartphone or other user device linked to the user's identity and/or entry into the unit can be used to provide various other features to the user. Although specifically described with respect to a smartphone any other user device having similar capabilities, such as, for example, a tablet or laptop computer, smartwatch, NFC devices etc. could accommodate such features. In certain embodiments, no device is needed to link a use to a specific identity or user account, for example by including a retinal scanner housed on the exterior of the amenity, a finger print scanner housed on the exterior of the amenity, or a code that the user knows that can be communicated to the unit, such as via a keypad.

For example, a user may be able to flush the toilet from the user's phone in order to provide a more sanitary and user-friendly experience. The toilet could be flushed by the user entering a command in a software application linked to a unit, sending a text message, or other device interaction. To provide for only authorized uses, the function can be limited only to the phone that was used for that entrance into the unit or is otherwise linked to the profile of the user currently logged as occupying that particular amenity in the backend of the central software system or locally at the unit. The function can further be available only while the user (i.e., the phone's GPS location and/or occupancy sensor) is located within the unit during that usage session.

A user may also be able to access consumer goods during a usage session using the user's phone. For example, typical products that may be needed or desired by a user while in a bathroom, such as, for example, toiletries, consumables, feminine products, sexual health products, bottled water, phone charger, food or beverages or other goods, can be provided in a locked cabinet within the unit. By executing a command with the user's phone, and if the user has a credit card or another form of payment on file, the cabinet can be unlocked and the user may be able to access the goods inside the cabinet. In some scenarios access to the cabinet is based on the user's current account type as logged in the backend of the userbase management system or similar software system. The cabinet door or walls may be transparent. The cabinet may have on it a QR code. In some embodiments, the cabinet door automatically unlocks or physically opens partially or all the way immediately upon entry of a user with a particular user account type or account preference. The cabinet and/or goods could include sensors or other means to track an inventory of the products and detect any products that are taken by the user from the cabinet. Such sensors may include weight sensors within or along the shelves of the cabinets. Example sensors can further include pressure based electrical sensors. The user's payment method on file with the system may then automatically be charged for the products taken by the user. Alternatively, a user may be able to enter payment information after accessing the cabinet.

There are many other functions that the system can optionally be set up to enable a user to carry out from the user's authorized phone during the usage session including, for example, turning on the sink, dispensing soap, locking, unlocking and/or opening the door, calling for help, flushing the urinal, opening a cleaning cabinet, turning on or off or modifying brightness of the lights, turning on or off or changing the volume or type of music or other audio-based media in the unit, changing ventilation or HVAC settings, and changing content or skipping advertisements displayed on a video screen or played over the audio system. Additional interactive features may also be provided within the software application during the usage session such as an ability to extend an allotted duration of time of the session (if the session is for a limited period of time), an option to rate the cleanliness of the unit and games or other interactive features available on the phone only during use of the unit.

One interactive feature that can be available in portable bathroom units described herein is a virtual graffiti feature designed to provide entertainment to the user during use to enhance the user experience. This feature can be a smartphone camera based, augmented reality service that enables users to draw digital messages, pictures, symbols, etc. on the walls or surfaces of the interior of the unit with the user's finger, stylus etc. on the user's device by pointing the camera at the wall or surface and interacting with the screen of the device. In another embodiment, the user can draw digital messages, pictures, symbols, etc. on the walls or surfaces of the interior of the unit by drawing directly on the wall or surface with the user's finger, or with the user's finger substantially close to the wall or surface, while pointing the camera of the smartphone at the wall or surface and finger. Certain digital tools can also be available through the software application for creating designs, such as alterations to the interior aesthetic as viewed through the mobile portal, including wall color changes, pattern changes, or hidden figures, virtual presents, virtual characters, virtual signage, virtual promotions or advertisements, or any digital representation of the interior of the present unit. The software application can also include an ability for users to view the digital messages, pictures, symbols, etc. previously drawn by the user and/or previous users from the same bathroom unit or similar bathroom units. This feature can further include meta data about the drawings of other users, such as, for example, time and data of drawing, geographic location of drawing (which unit), account name/avatar of the creator of the drawing, etc. The content can be monitored such that offensive or otherwise unacceptable content can be edited or erased according to predetermined policies or as otherwise determined by a review of the content. This can include providing users with the ability to flag content for review or removal while within a unit. At regular intervals, whether based on amount of content or time-based, the system can erase all content to provide a clean surface for subsequent users. In some embodiments, user's may be able to like, dislike, rank, etc. previous content with more highly rated content remaining on the walls longer and lower rated content being removed sooner.

Additional digital experiences may also be able to be employed within units including visual gifts/presents or “easter eggs” placed digitally within the unit via the software application for other users to find via the application. In various embodiments, these easter eggs may be viewable only through certain application modules, upon entry into the unit, or may appear during use of the unit or at the end of use. For example, when a user enters the unit, a virtual present could be waiting on the floor in the unit as viewed on the user's software application. The user can collect and open the present to receive any number of gift or privileges such as, for example, an NFT (that can be placed in an NFT wallet in the application), credits for free premium access to the unit, access to special amenities, etc.

### Efficient Operations

Portable bathroom units as described herein can employ various other procedures to aid in efficiently operating and maintaining the units.

For example, units as described herein can employ smart pump predictions to aid in more timely determination of whether the tanks in the unit need to be pumped and to avoid delayed pumping or unnecessary pumping. In embodiments, the various unit tanks, such as the freshwater tank, grey water tank and the wastewater tank can include volume sensors that sense the volume of liquid in the tanks. The system can also store historical usage data on how frequently the unit has been used in the past for various dates, times of year, events, etc. A predictive utilization model can use the historical data to predict how heavily the unit will be used in the near future. Based on a combination of volume (volume remaining in the fresh tank, volume available in the waste tank) and predicted usage, the system can predict when the freshwater tank will need to be refilled or the wastewater tank emptied to optimize the number of services needed at the unit.

Similarly, rather than having predetermined cleaning times, bathroom units as described herein can employ a system that utilizes various information to remotely determine whether a unit needs to be cleaned. In embodiments, each unit can be provided with a real-time cleanliness score generated based on the information. Cleanliness score information can include, for example, one or more of user feedback providing a cleanliness rating in the software application (including a mobile app, SMS module or other) upon entering or following use of the throne, smell sensor data (e.g., methane or other volatile organic compound sensors or air quality sensors) and imaging data, e.g., images of the interior of the unit taken by an external camera angled inward when the door is open. In the case of user feedback based cleanliness scores, certain weighting or adjustments may be made to an incoming score, based on the historical rating profile of that user, and certain assertions that can be made about the relative harshness or leniency of that rater compared to other users. Cleanliness scores calculated from these factors can be sorted to provide a ranked cleanliness score that, in combination with geographical location, predicted utilization (as described above) and other factors can be used to determine the most effective cleaning prioritization in a network of cleaning units. Cleanliness scores can also be used to manually or automatically switch a unit to an offline mode that makes the unit unavailable for use to minimize users having an unpleasant experience from a verified low cleanliness unit. In embodiments, the unit being automatically or manually set to unavailable is implemented through a change by the System (200) such that digital representations of that amenity, as communicated down to user facing devices such as the software application, SMS client or other user devices, is shown to be currently unavailable, out of service, and in some embodiments, an explanation as to why the unit is unavailable is given. In some embodiments, map based interfaces show the unit as unavailable or remove the unit entirely from view on the map. In embodiments, when a user attempts to utilize an unavailable unit, such as via an SMS message, the unit will not open, and a communication is provided to the user that the unit is unavailable. In some embodiments, a digital sign on the exterior of the unit depicts the unit is unavailable or out of service. Verification can be based on one or more of multiple very low reviews from users over a threshold number of reviews, a single or lower number of very low reviews from users with histories of accurate reviews, a single or lower number of reviews supplemented with additional information such as pictures, comments or answers to follow up questions and/or information from smell sensors or from the external camera.

Whereas typical portable bathrooms require an in person visit to solve many issues that can occur, portable bathroom units as described herein can provide for more efficient operations through the use of remote technical visits.

For example, a unit can include a system that can remotely detect a clogged toilet, attempt to remotely test for a clog and either bring the unit offline until service can be provided or have the unit remain in/return to available status if the issue can be fixed. Clogs can be detected by one or more of a flow meter positioned downstream of the toilet, visual images of the toilet taken by the external camera, audio sensors in or near the interior of the amenity with software configured to detect the sound of a clogged toilet and user complaints. The bathroom unit can be provided with a remote flush feature that is enabled by connecting an electrical relay to the flushing mechanism, which is in turn connected to the unit's control board, which is connected to the central processor for the unit that can communicate with the central management system wirelessly over the internet (e.g., in the cloud). When a probable clog is detected, the remote flush feature can be utilized to activate the flushing mechanism by sending a signal from the central management system either manually through personnel working at central management or automatically based on pre-set clog restoration protocols. (Note that a similar system would be employed to carry out the flushing from the software application and other similar functions described above). Following the remote flush, the system can use one or more of the methods noted above to determine if the unit is operating properly and, if not, can schedule maintenance and/or bring the unit offline to be unavailable for use.

Other technical issues with the unit can be attempted to be resolved remotely. For example, any hardware or software issues that could potentially be remedied by a hard reset of the power of the unit can be addressed by a remote reset to the power similarly accomplished through an electrical relay to the central processor or the main power supply to the unit. This reset could be executed either manually by personnel at the central management location or automatically based on various predetermined criteria.

Bathrooms units as described herein can in some embodiments also include an automatic door monitoring and testing system that aids in efficiently operating and maintaining the units. Such a system can passively monitor the functionality and status of the powered door and may be able to detect potentially maintenance needs in advance of potential door functionality issues. In embodiments, this system can employ real-time monitoring and reporting of motor torque required to open and/or close the door across multiple open/close cycles and monitoring of deviations from expected magnitudes can indicate a potential problem that may require maintenance. Similarly, the system can alternatively or additionally include real-time monitoring of door open and/or close times with deviations from expected times indicating a potential need for maintenance. Visual imaging from the external camera, positioned in a location such as on the underside of the exterior awning of the door opening and closing can alternatively or additionally be employed to detect potential door operation issues. A further potential option is computing and monitoring statistics relating to customer satisfaction and entry/exit success rates across multiple open/close cycles with deviations from expected values indicating a possible need for service. Door testing can include a system of periodic health checks during low utilization times during which the system can run a series of dynamic tests of the door opening and closing frictions (based on door motor torque), open/close time, and other data that can be recorded through a software mediated testing function.

In embodiments, a sensing module can be placed on the overhang, or on the door frame exterior to the door, such that when door 122 is in an open position data regarding the state of the enclosed space can be collected. Placement of such a sensing module, such as a camera, can enable data to be collected from the interior of bathroom 100 while complying with privacy regulations. In embodiments, the System (200) may run through an internal cabin evaluation sequence which involves: 1) a confirmation that the unit is unavailable by checking the unit's occupancy sensors and occupancy sensing algorithm output, 2) remotely triggering a door open sequence, and 3) initiating one or more still pictures or a short period of video to be taken from the external camera oriented towards the interior of the unit. In embodiments, the third step also includes orienting the camera inward if the camera has automatically configurable orientation. This sequence may be initiated by several inputs including: automatically at a pre-selected time, upon a specific trigger, or based on a manual command by an operational or monitoring worker from the backend. Specific triggers may include complaints from recent or previous users that the unit is dirty, that the toilet won't flush or is clogged, or that some aspects of the interior of the unit needs service, including providing a low cleanliness rating. In embodiments the camera is positioned and angled such that it can see into the toilet bowl.

In embodiments the cabin evaluation sequence is extended to a toilet clog repair sequence, where upon opening the door and taking a picture of inside the toilet, the system assesses if the toilet is clogged or unflushed. In embodiments the system processes this image automatically with machine learning algorithms or manually via a remotely monitoring human, and a remote toilet flush may be triggered. A second or second set of images is then triggered by the camera to see if the toilet clog has been repaired with the same manual or automatic sequence as before the flush. If the toilet has not been repaired, the unit may stop the sequence, set the unit into an offline state and trigger an in-person service visit. In other embodiments, the system may then proceed to a more aggressive anti-clog sequence including initiation of a macerator pump or other pump or a robotic plunging sequence if the toilet is configured with an articulating plunger or declogger that may be remotely actuated. Such a plunger may include a plunging unit on an articulating arm connected to a motor that can provide longitudinal motion. If the toilet repair sequence is successful and the after flush picture depicts a flushed toilet, the unit may be returned to available with the door closed and the customer complaint logged as fixed without further service.

In other embodiments a camera is replaced by an audio sensor, an in toilet sensor, a pressure sensor, a flow sensor downstream of the toilet, or other means to check if a clog has been fixed by an automatic or remote action. In some embodiments the first step of the sequence of confirming a lack of occupancy, may be skipped for safety related reasons, for example if a particular use session has gone exceedingly long and a user will not leave, or if a user messages for help or assistance, or if a certain safety word is registered in the system (such as a text message saying “help” or “danger”), or if an internal “panic button” is triggered by an internal user.

### Smart Cleaning and Stocking Mode

Portable bathroom units can employ various features to aid in efficient cleaning and maintenance of the units. For example, units may include a smart cleaning supply cabinet that is locked and contains various cleaning supplies and configured with a smart lock connected to the central control system of the unit. Upon entry of particular authorized users and/or after entry of particular authorization codes, the unit may enter a cleaning mode, which affects the access and automation of the unit. Authorized users may include company personnel, authorized third party service providers, gig-workers with a special cleaning app or cleaning access privileges. ‘Authorized users’ might include gig-force workers who are notified of a need for the bathroom to be cleaned and may accept or reject the request based on dollar amount offered, location, cleaning requirements, etc. While in cleaning mode, the amenity may grant access to the cleaning supply cabinet by unlocking it or automatically physically opening it, granting access to the cleaning supplies therein. Weight sensors or other sensors employed within the cabinet can track the stock level of the various cleaning supplies and consumables to aid in efficiently restocking of the cabinet via notifications to the backend software system. In some embodiments the cleaning mode also changes other aspects of the unit's automation firmware including leaving the main door of the unit open in cleaning mode so that cleaning fumes are not harmful to the cleaner, disabling any extended occupancy automation that might otherwise apply to users of the amenity, change the amount or frequency of water that can be accessed by the cleaner, change the access levels to audio or entertainment within this unit, change the ventilation settings, or other changes to lighting energy utilization, HVAC or other automated controls. In some embodiments, images of the interior of the unit taken by the external camera when the door is open can be reviewed to visually assess the cleanliness of the unit to help determine when cleaning is required.

### Smart Plumbing

Embodiments of portable bathroom units described herein can include smart plumbing features that can provide for more efficient and ecofriendly water usage than is available in conventional portable bathrooms.

One such feature is a system configured to conserve water in the bathroom. Such a system can include a “graywater” (i.e., used water from the sink) reservoir that captures water downstream of the sink. A sensor can track the volume of water in the graywater reservoir. When there is sufficient graywater available, the water can be reused for flushing of the toilet and/or the urinal in the unit. A secondary pumping mechanism can be employed to route the graywater to the toilet and/or urinal automatically when sufficient water is available or otherwise intermittently or on command.

As noted above, another smart plumbing feature can be employed to inhibit freezing of water in the system during cold conditions. One or more temperatures sensors can be disposed in various water storage and/or transport areas and upon crossing a threshold temperature a system can be activated to move the water around to lower the freezing temperature of the water and prevent the water in the unit from freezing. Such water movement system can further be employed for maintenance purposes during low utilization times.

Another feature that can be employed in various embodiments is a wastewater reduction system. Such a system can include a mechanism for separating pure water from wastewater within or near to a wastewater holding tank, such as by centrifugal motion through a filter. The filtered out water can then be evaporated using one or more of powered fans, exposure to external winds/air flow, heating or other means to reduce the volume of wastewater storage and extend the time needed in between maintenance visits.

Another feature in some embodiments is a rainwater capture system. Such a system configured on or on and around the roof is configured to catch rainwater falling onto the roof, and funneled with a system of rails, cutters or angled surfaces into an inlet port which may be connected directly to a freshwater tank. In other embodiments, a smart valve system is used, that is paired with information about the current volume within the freshwater tank, and will choose to allow freshwater into the freshwater tank if there is room, but otherwise is configured to drain the water through an exit port that connects to the exterior of the unit. In other configurations, a pressure sensor is configured within the rainwater capture inlet or in the piping that connects the inlet to the freshwater tank. Such a sensor alerts the processor of the unit or the System (200) how much water is currently in the pipe, which may impact the logic for if the inlet is opened to allow water to be pumped into the freshwater tank.

Another feature in some embodiments is a combined holding tank separated by a movable membrane, separating two sides of the tank, establishing a freshwater side, and a wastewater side. In one embodiment of this feature, the tank could be positioned to stand up within a wall of the amenity, with a large near rectangular shape, and a dynamic membrane extending within the tank vertically along the centerline of the thickness of the tank. The tank has an inlet to allow filling of fresh water on one side of the tank. Upon filling an otherwise empty tank, the water enters the fresh water side and acts to fill up the fresh water half of the tank, and then continued filling allows the water to push the dynamic membrane towards the other side of the tank, that is currently empty, so that the fresh water side of the tank temporarily houses more volume than half of the total internal tank volume, up to just under 100% of the entire volume of the tank. Over the course of normal operation of the amenity, fresh water is pumped out of the freshwater side of the tank and into an internal amenity, such as a sink, toilet or urinal, via a pump or gravity, to be utilized in some way. This act on average leads to the addition of some form of waste to the water, making it wastewater. That wastewater will then be pumped back into the two-chamber tank, this time on the wastewater side. In some embodiments the wastewater is first sent through a macerator pump before entering the two-chamber holding tank. Due to the fact that the waste water volume is inversely proportional to the fresh water supply, with some coefficient associated with the amount of waste added to the fresh water used per gallon, as long as sufficient room is left initially in the amount of freshwater included on the freshwater side of the tank, for example utilizing 80% of the total volume of both chambers, the tank will continue to function with the dynamic membrane changing position as the freshwater leaves the freshwater side of the tank and as new wastewater enters the wastewater side of the tank, until the freshwater is empty, and the wastewater side of the tank is now taking up most or all of the total volume of both tank compartments. This design is more space efficient than two separate tanks holding the same amount of freshwater and wastewater, respectively. The dynamic membrane can be made out of a non-stretchy material, but with sufficient flexibility and extra slack to be able to flap from one side to the other, such as a non-water permeable nylon partition. In other embodiments the membrane is stretchy and able to stretch in one direction or the other until in contact or in near contact with the other far wall of the opposing tank. Such materials might be rubber or similar.

Some embodiments can include a wastewater volume sensing system that has the ability to sense the relative volume of a wastewater tank. The system is configured to keep dirty matter away from sensing components. One embodiment is a cylindrical container positioned to be submerged within the contents of a wastewater holding tank with a filtering mechanism provided around the circumference of the cylinder along the entirety or most of the entirety of height of the cylinder to allow water into the interior of the cylinder but not allowing waste material or dirty matter above a certain particulate size into the interior of the cylinder, a float based volume sensing system such as a buoyant object constrained within the cylinder, and a voltage measurement system used to measure the relative vertical position of the buoyant object within the cylinder. In embodiments, the position of the buoyant object is based off optical measurements of its relative position, such as a time of flight sensor.

In other embodiments, wastewater treatment is employed to either decrease odors associated with wastewater, increase the length of time wastewater can be held without pumping, or to create a useful biproduct from the wastewater on premises, or to begin a process of treatment on a wastewater holding sample prior to transportation to another facility to continue processing to create a useful biproduct. Useful biproducts include fertilizer, energy sources, or other known useful biproducts of human waste. Such a system may include a filtering mechanism that is assisted by gravity and contours within the wastewater holding tank such that solid matter is congregated in a specific and known location. In other embodiments, pumps such as aquarium pumps are also used to help configure solid waste into a useful location within the tank. In embodiments, the human waste contents can then be treated with specific enzymes, biological flora, bacteria, fungus, or bioengineered chemicals, or non-biological chemical compositions to begin transforming the human waste into a useful bioproduct. In embodiments, the wastewater tank is outfitted with a pressure release valve which automatically opens to vent gaseous byproducts of chemical reactions when the pressure within the tank exceeds a threshold pressure.

### Data Collection Techniques

Embodiments of portable bathroom systems disclosed herein can apply data collection techniques towards an aggregated biodata and infectious disease monitoring system. Such a system can pull a sample of wastewater for testing at each or intermittent wastewater pumping cycles or at some point in between wastewater cycles. The sample can be pulled in such a manner so as to maintain the integrity of the sample and document the time, date and location of that sample while in transport to an infectious disease evaluation lab. A processing system can take any positive readings from a given sample and connect the same to a specific bathroom unit and a specific time period during which the pathogen might have ended up in the wastewater storage tank based on historical usage data and the labeling of the sample. A processing system may also attribute certain biodata, to a specific individual or group of individuals, with any personalized data only being collected from well informed and consented participants, for communication back to the individual, or processing, logging or aggregation for scientific or health related reasons, or for other uses. Data labeling may occur physically on the sample or digitally logged. A system could then be employed to sterilize the tank from which the infected sample was taken via injection into the tank, with a sterilizing agent of sufficient density, and given sufficient time to sterilize the tank.

An automated biological data collection system is described that may only be used with users who have opted into a health monitoring plan. An automated system is installed in a normal functioning toilet that can: sample human fecal matter, encapsulate a small volume (0.5-20 g) of that fecal matter in a capsule sufficiently impermeable to water or other external dissolvents, sufficient to allow the contents of capsule to remain sufficiently unaltered for a period of time similar to the time it takes sewage to get from a toilet to a water treatment plant. The system is able to serialize the capsule with a unique identifier which can later be linked to a time and source (location) of capsulation, including in which amenity it was collected, and the unique identifier of that user in the amenity for that use. The capsule can be flushed down the toilet like normal. In embodiments, the piping on the way into the wastewater holding tank has a mechanism to catch the capsule and siphon it off to a specific holding area. In other embodiments, the capsule is captured later when pumping with the use of a filter on the end of the vacuum hose, and in the meantime is just immersed within the wastewater tank. At the point of collection, the capsule is distributed to a proper biological data processing center so that the contents of the capsule can be analyzed for microbiotic information. In embodiments, the automated system above is described, but wherein human fecal matter is replaced by a blood sample, a urine sample, a saliva sample, a skin sample, a semen sample, a genital swab, an intranasal or throat swab, or any biologic materials. In embodiments, the capsulation technique includes the printing of a unique QR code on to the sample, which is linked to the unique usage ID linked to the use of that amenity. In other embodiments, the same method can be used in a normal plumbed toilet connected to the sewage grid as opposed to in a disconnected portable amenity, and the capsule is collected downstream at a wastewater treatment plant with means such as magnetic filtering or other filtering techniques.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A smart bathroom facility, comprising:
a structure containing one or more bathroom elements and including at least one processor and a battery configured to provide power to one or more of the bathroom elements; and
an occupancy sensing system within the structure and communicatively linked to the at least one processor such that the processor can determine from data from the occupancy sensing system whether a user is present within the structure;
wherein one of the bathroom elements is an HVAC system, and wherein the at least one processor is configured to control the HVAC system to selectively modify one or more of heating, air conditioning and ventilation services based on the data from the occupancy sensing system in order to conserve power in the battery.

2. The smart bathroom facility of claim 1, wherein the processor is configured to provide one or more of heating, air conditioning and ventilation services for an entire time that the user is present within the structure.

3. The smart bathroom facility of claim 1, wherein the processor is further configured to provide one or more of heating, air conditioning and ventilation services for a period of time directly after the user was present within the structure.

4. The smart bathroom facility of claim 1, wherein the processor is configured to provide one or more of heating, air conditioning and ventilation services for a portion of a time that the user is present within the structure.

5. The smart bathroom facility of claim 1, wherein the processor is configured to provide one or more of heating, air conditioning and ventilation services based on a location of the user within the structure.

6. The smart bathroom facility of claim 1, wherein the at least one processor is further configured to control the HVAC system based on a current energy of the battery.

7. The smart bathroom facility of claim 6, wherein the at least one processor is further configured to control the HVAC system based on a current energy of the battery based on a combination of the data from the occupancy sensing system and currently energy level of the battery.

8. The smart bathroom facility of claim 6, further comprising a solar energy system configured to provide power to the battery, and wherein the at least one processor is further configured to control the HVAC system based on a current energy of the battery based on a currently level of solar power generation by the solar energy system.

9. The smart bathroom facility of claim 1, wherein the at least one processor is further configured to control the HVAC system based on a combination of the data from the occupancy sensing system and future predicted energy needs of the structure.

10. The smart bathroom facility of claim 9, wherein the at least one processor is configured to determine future predicted energy needs based on a weather forecast for an area where the structure is situated.

11. The smart bathroom facility of claim 9, wherein the at least one processor is configured to determine future predicted energy needs based on predicted future usage of the structure.

12. A smart bathroom facility system, comprising:
a plurality of amenities, each amenity comprising a structure including at least one processor and containing one or more bathroom elements including a freshwater holding tank configured to contain freshwater;
an operations management system communicatively coupled to the at least one processor of each of the plurality of amenities; and
a water volume sensor configured to measure a volume of water with the freshwater holding tank of at least some of the amenities,
wherein the operations management system is configured to monitor the volume of water within the freshwater holding tank of the at least some of the amenities and to prioritize routing of one or more service vehicles to the at least some of the amenities based on the volume of water within the freshwater holding tank of the at least some of the amenities.

13. The smart bathroom facility system of claim 12, wherein the operations management system is configured to give a higher priority to amenities having a lower volume of water in the freshwater holding tank.

14. The smart bathroom facility system of claim 12, wherein the at least one processor of each of the plurality of amenities is configured to automatically switch the corresponding amenity to an offline mode in which the amenity is unavailable for normal use if the water volume sensor for the amenity indicates that the volume of water is below a low threshold in the freshwater holding tank of the amenity.

15. The smart bathroom facility system of claim 12, wherein the operations management system is configured to automatically generate a service request for an amenity if the water volume sensor for the amenity indicates that the volume of water is below a low threshold in the freshwater holding tank of the amenity.

16. A smart bathroom facility system, comprising:
a plurality of amenities, each amenity comprising a structure including at least one processor and containing one or more bathroom elements; and
an operations management system communicatively coupled to the at least one processor of each of the plurality of amenities, wherein the operations management system includes a cleanliness tracking system configured to receive user reviews of the plurality of amenities to determine a cleanliness status for each of the amenities,
wherein the operations management system is configured to cause the at least one processor of an amenity to switch the amenity into an offline mode in which the amenity is unavailable for normal use based on the cleanliness status of the amenity.

17. The smart bathroom facility system of claim 16, wherein the at least one processor of an amenity in the offline mode is configured to indicate that the amenity is unavailable for normal use on an external sign of the structure of the amenity.

18. The smart bathroom facility system of claim 16, wherein the at least one processor of an amenity in the offline mode is configured to indicate that the amenity is unavailable for normal use on a user device of a user attempting to gain access to the amenity.

19. The smart bathroom facility system of claim 16, wherein the operations management system is configured to prioritize routing of one or more service vehicles to the plurality of amenities based on the cleanliness status for each of the amenities

20. The smart bathroom facility system of claim 16, wherein the operations management system is configured to automatically generate a service request for an amenity that has been switched to the offline mode.
